(19) United States
(12) Patent Application Publication
(10) Pub. No.: US 2018/0224035 A1
(43) Pub. Date: Aug. 9, 2018

(54) Connecting Arrangement and Press Ring for A Connecting Arrangement

(71) Applicants: Christoph STEINKAMP, Biebergemünd (DE); Andreas BAUER, Obernburg (DE); Sven KULLIK, Langenselbld (DE)

(72) Inventors: Christoph Steinkamp, Biebergemünd (DE); Andreas Bauer, Obernburg (DE); Sven Kullik, Langenselbold (DE)

(21) Appl. No.: 15/750,413

(22) PCT Filed: May 24, 2016
(86) PCT No.: PCT/EP2016/061708

§ 371 Date: Feb. 5, 2018

(30) Foreign Application Priority Data
Aug. 18, 2015 (DE) 10 2015 113 626.0

(51) Int. Cl. F16L 33/03

(52) U.S. Cl. CPC F16L 33/03

(57) ABSTRACT

The invention relates to a connecting arrangement having a connecting piece (2) and a hose (3), wherein the hose (3) is pushed with one hose end (5) onto the connecting piece (2). In order to be able to ensure secure retention even during tool-free mounting, a press ring (4) is arranged at the hose end (5), surrounding the hose (3) on the outside, wherein the press ring (4) is retained on the hose end (5) by a friction fit. The invention further relates to a respective press ring.

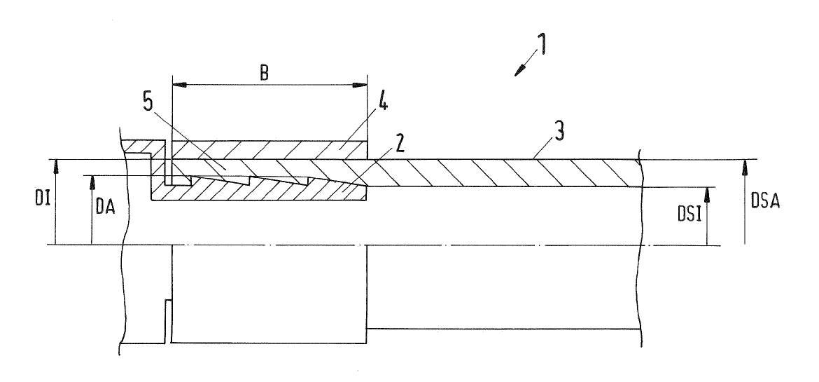

The invention relates to a connecting arrangement having a connecting piece and a hose, wherein the hose is pushed onto the connecting piece by way of a hose end. In addition, the invention relates to a press ring for such a connecting arrangement.

Pushing hoses, for example, onto a connecting piece of a tank by way of their hose ends and securing them with a hose clip, which is placed around the hose end in the region of the connecting piece, is known. Relatively pressure-resistant and tension-resistant connections can be achieved in this way. However, the arranging of a hose clip requires additional grips and is consequently relatively costly.

In the cases where the hoses have a relatively small diameter and internal pressure produced by the conveyed medium is not too high, it is also known simply to push the hose ends onto the connecting piece and to leave them there without further securement. For this purpose, an external diameter of the connecting piece, as a rule, comprises an oversize in relation to an internal diameter of the hose end such that the hose end is widened when pushed onto the connecting piece and then holds in a friction-locking manner. In order then to obtain a particularly secure hold, it is additionally known to provide the connecting piece with a corresponding outer structuring, such as, for example, a pyramid-like structure.

In the cases where the hoses have larger internal diameters and/or the thickness of the material of the hoses is thin, the radial clamping forces obtainable as a result of widening the hose end when it is pushed onto the connecting piece are, however, not sufficient to hold the hose end securely on the connecting piece.

The object now underlying the invention is to provide a connecting arrangement which enables the hose end to be held securely on the connecting piece with little expenditure. In this case, the connecting arrangement is to be produced in a cost-efficient manner with as little expenditure as possible and is also to enable use in confined spaces.

Said object is achieved according to the invention by a connecting arrangement with the features of claim 1 and by a press ring with the features of claim 12. Advantageous configurations are to be found in the subclaims.

In the case of a connecting arrangement having a connecting piece and a hose, wherein the hose is pushed onto the connecting piece by way of a hose end, it is provided according to the invention that a press ring, which surrounds the hose on the outside, is arranged on the hose end, wherein the press ring is held in a friction-locking manner on the hose end.

The press ring therefore does not require any additional fastening and/or clamping means but is held on the hose end exclusively in a friction-locking manner. The friction-locking hold is produced, in this case, by radially inwardly acting clamping forces which are produced as a result of the press ring widening radially when it is pushed onto the hose end and/or when the hose end with the press ring already mounted is pushed onto the connecting piece. The hose end can therefore be pushed onto the connecting piece with the press ring already pre-mounted such that a secure connection can already be obtained with few grips. The press ring, in this case, prevents the hose end widening too much and at the same time strengthens the radially inwardly acting clamping forces. As a result, it provides a secure hold of the hose end on the connecting piece. As no direct access to the press ring has to occur, said connecting arrangement is also able to be used where space is confined. By dispensing with additional connections, for example a welding or bonding connection between the press ring and the hose end, there is, on the one hand, very simple production and, on the other hand, a high degree of variability when selecting the material for the hose and for the press ring. Combinations of connecting pieces and hose ends, which in themselves have a bad interface performance, can be simply secured to one another by means of the press ring. Thus, for example, chemically resistant materials with few good mechanical properties can also be used without any problem. Good mechanical hold is achievable even then by means of the press ring.

The press ring produces an increased sealing action between the hose end and the connecting piece such that it is possible to dispense with additional sealing elements such as, for example, a sealing ring on the connecting piece. This then results in less installation space being required and in a further simplified design.

In a preferred manner, in this case, the internal diameter of the press ring in the unloaded state is between 0 and 5% smaller than the sum of an external diameter of the connecting piece and double the thickness of the material of the hose on the hose end. This ensures that the press ring has to be expanded radially when the connecting arrangement is mounted and introduces correspondingly radially inwardly acting clamping forces into the connecting arrangement. The press ring is therefore held on the hose end in the manner of a press fit.

In a preferred embodiment, the internal diameter of the press ring corresponds to an external diameter of the hose end prior to being pushed onto the connecting piece, wherein an internal diameter of the hose on the hose end is smaller than the maximum external diameter of the connecting piece. As a result, it is possible in a relatively simple manner to pre-mount the press ring on the hose end before the hose end is pushed onto the connecting piece. The press ring can be pushed onto the hose end using very little force, the hose end then being widened together with the press ring when pushed onto the connecting piece. The connecting piece only has to have a slightly larger external diameter for this than the internal diameter of the hose end. For example, the external diameter of the connecting piece is between 0 and 5% greater than an internal diameter of the hose end.

The solution according to the invention is usable, in principle, with all hose diameters for increasing the pull-off force and torque. Even in the case of small diameters, materials with less good interface characteristics can consequently be used. In a preferred manner, an internal diameter of the hose can be more than 20 mm, in particular more than 30 mm. The connecting arrangement is consequently also suitable for larger flow rates.

The press ring is advantageously realized less elastically than the hose. This can be achieved in various ways, for example as a result of selecting the material in a corresponding manner or as a result of the material of the press ring being thicker than that of the hose. If the press ring is realized less elastically than the hose, the essential clamping forces, which are required to hold the hose end on the connecting piece, are introduced by the press ring. At the same time, the hose can itself be configured in a very flexible manner, which is advantageous for many intended applications.

A width of the press ring preferably corresponds to a depth of penetration of the connecting piece into the hose end. Consequently, a best-possible overlap is produced which contributes to a secure hold.

In a preferred configuration, the connecting piece comprises a pyramid-like structure on the outside. This produces a particularly secure hold of the hose end on the connecting piece, where applicable the pyramid-like structure even being able to penetrate slightly into an inside surface of the hose in order to produce an additional positive locking connection in this way. The connecting arrangement is consequently also suitable for higher internal pressures.

The hose is preferably formed from a plastics material. The press ring can also be formed from a plastics material. The connecting arrangement can consequently be produced in a very cost-efficient manner, the desired elasticity of the press ring or of the hose being easily adjustable as a result of the choice of suitable plastics material.

In a preferred embodiment the hose is realized as a corrugated tube, wherein, in particular, a circumferential surface of the hose end is realized with a smooth surface. A corrugated tube comprises a high degree of flexibility and enables the hose to be installed in a very flexible manner. As a result of the circumferential surface being configured with a smooth surface on the hose end, contact with the press ring and also with the connecting piece can nevertheless be obtained over a large surface area.

In an alternative configuration, the hose comprises a smooth outside surface. In this case, the hose has, in particular, a constant internal and external diameter over its entire length, that is to say also at the hose end.

The invention is also achieved by a press ring for a connecting arrangement according to one of claims 1 to 11. The press ring, in this case, is in particular formed as a non-slotted ring produced from a plastics material which is elastically deformable. In this case, the press ring should, however, have a certain compressive strength.

The invention is described in more detail by way of a preferred exemplary embodiment in conjunction with the drawing, in which: the single FIGURE shows a part-sectioned view of a connecting arrangement.

The FIGURE shows a connecting arrangement 1 which includes a connecting piece 2, a hose 3 and a press ring 4. The hose 3 has been pushed onto the connecting piece 2 by way of its hose end 5. As an external diameter DSA of the connecting piece is greater than an internal diameter DSI of the hose 3 in the region of the hose end 5, the hose end 5 has been widened radially as a result of being pushed onto the connecting piece 2. The press ring 4, which surrounds the hose end 5 in the region of the connecting piece 2, has, as a result, also had to be widened radially such that, overall relatively high radially inwardly working clamping forces occur which hold the hose end 5 securely on the connecting piece 2.

The external diameter DSA of the hose 3 in the region of its hose end 5 corresponds, in this case, prior to being pushed onto the connecting piece 2, substantially to an internal diameter DSI of the press ring. The press ring 4 can, as a result, be pushed onto the hose end 5 relatively simply prior to the hose end 5 with the press ring 4 being pushed onto the connecting piece 2.

A width B of the press ring 4 corresponds in the case of said exemplary embodiment to a depth of penetration of the connecting piece 2. Force is transmitted over a large area as a result.

In order to obtain a particularly secure hold, in the case of said exemplary embodiment an outside surface of the connecting piece 2 is provided with a pyramid-like structure which is pressed in part into an inside surface of the hose end 5.

The invention is not restricted to the afore-described exemplary embodiment, but can be converted in diverse ways. Thus, the hose can be configured, for example, as a corrugated tube. It is also not absolutely necessary for the connecting piece to comprise a pyramid-like structure. As an alternative to this, the connecting piece can comprise, for example, a smooth surface or a grooved or ribbed surface. The press ring can also comprise a width that is smaller than the depth of penetration of the connecting piece. This depends essentially on the requirements to be met in particular regarding the compressive strength.

The invention produces a connecting arrangement for hoses which is particularly simple to produce and is also usable where the hoses have larger internal diameters. Nevertheless, a secure connection of the hose end on the connecting piece is obtainable which also allows for a higher internal pressure. In this case, the terms hose or hose end, in principle, also include tubes and tube ends.

All features and advantages which proceed from the claims, the description and the drawing, including structural details, spatial arrangements and method steps, can be essential to the invention both on their own and also in the most varied combinations.

### LIST OF REFERENCES

1 Connecting arrangement
2 Connecting piece
3 Hose
4 Press ring
5 Hose end DSA External diameter DSI Internal diameter
B Width

1. A connecting arrangement having a connecting piece (2) and a hose (3), wherein the hose (3) is pushed onto the connecting piece (2) by way of a hose end (5), characterized in that a press ring (4), which surrounds the hose (3) on the outside, is arranged on the hose end (5), wherein the press ring (4) is held in a friction-locking manner on the hose end (5).

2. The connecting arrangement as claimed in claim 1, characterized in that the internal diameter DSI of the press ring (4) is between 0 and 5% smaller than the sum of an external diameter of the connecting piece (2) and double the thickness of the material of the hose (2) on the hose end (5).

3. The connecting arrangement as claimed in claim 1, characterized in that the internal diameter DSI of the press ring (4) corresponds to an external diameter DSA of the hose end (5) prior to being pushed on the hose connecting piece (2), wherein an internal diameter of the hose (3) on the hose end (5) is smaller than the maximum external diameter of the connecting piece (2).

4. The connecting arrangement as claimed in claim 1, characterized in that the press ring (4) is realized less elastically than the hose (3).

5. The connecting arrangement as claimed in claim 1, characterized in that a width B of the press ring (4) corresponds to a depth of penetration of the connecting piece (2) into the hose end (5).

6. The connecting arrangement as claimed in claim 1, characterized in that the connecting piece (2) comprises a pyramid-like structure on the outside.

7. The connecting arrangement as claimed in claim 1, characterized in that the hose (3) is formed from a plastics material.

8. The connecting arrangement as claimed in claim 1, characterized in that the press ring (4) is formed from a plastics material.

9. The connecting arrangement as claimed in claim 1, characterized in that the hose (3) is realized as a corrugated tube, wherein, in particular, a circumferential surface of the hose end is realized with a smooth surface.

10. The connecting arrangement as claimed claim 1, characterized in that the hose (3) comprises a smooth outside surface.

11. A press ring for a connecting arrangement as claimed in claim 1.
